(19) United States
(12) Patent Application Publication
(10) Pub. No.: US 2026/0241573 A1
(43) Pub. Date: Aug. 20, 2026

(54) METHOD FOR CALIBRATING A LIGHT SECTION SENSOR, AND ASSOCIATED ROBOT SYSTEM

(71) Applicant: KUKA Deutschland GmbH, Augsburg (DE)

(72) Inventor: Thomas Elter, Eschau (DE)

(73) Assignee: KUKA Deutschland GmbH, Augsburg (DE)

(21) Appl. No.: 19/163,869

(22) PCT Filed: Feb. 15, 2024
(86) PCT No.: PCT/EP2024/053862

§ 371 Date: Sep. 10, 2025

(30) Foreign Application Priority Data
Mar. 3, 2023 (DE) 10 2023 105 361.2

(51) Int. Cl. B25J 9/16

(52) U.S. Cl. CPC B25J 9/1692; G05B 2219/39058

(57) ABSTRACT

A method and robot system for calibrating a light section sensor with respect to one member of a robot kinematics system which can be controlled by a robot control device and has a plurality of members and joints which adjustably connect the members to each other, wherein the light section sensor is fastened to the one member. The method includes, amongst other things, automatically moving the light section sensor in a first vertical position along a first section, which is parallel to the first line feature, in the direction of the second line feature of the calibration object until the projected line hits the second line feature of the calibration object, automatically moving the light section sensor along a second section, which is parallel to the first line feature and is different from the first section, in the direction of the second line feature of the calibration object until the projected line hits the second line feature of the calibration object, and automatically moving the light section sensor in a second vertical position, which is different from the first vertical position, along a third section, which is parallel to the first line feature and is different from the first section and the second section, in the direction of the second line feature of the calibration object until the projected line hits the second line feature of the calibration object.

### CROSS-REFERENCE TO RELATED APPLICATIONS

This application is a national phase application under 35 U.S.C. § 371 of International Patent Application No. PCT/EP 2024/053862, filed Feb. 15, 2024 (pending), which claims the benefit of priority to German Patent Application No. DE 10 2023 105 361.2, filed Mar. 3, 2023, the disclosures of which are incorporated by reference herein in their entirety.

### TECHNICAL FIELD

The invention relates to a method for calibrating a light section sensor with respect to one member of a robot kinematics system which can be controlled by a robot control device and has a plurality of members and joints which adjustably connect the members to each other, wherein the light section sensor is fastened to the one member. The invention also relates to an associated robot system.

### BACKGROUND

EP 1 931 503 B1 describes a method for determining the position of a virtual tool center point with respect to a known coordinate system of a robot with a robot arm, wherein first the position difference between a feature of a reference component and the virtual tool center point is determined, then the robot arm is moved until the coordinates of the feature of the reference component and the virtual tool center point match, and then the position of the virtual tool center point in the robot coordinate system is determined by ascertaining the robot axis positions for this position of the virtual tool center point.

### SUMMARY

An object of the invention is to provide a method for calibrating a light section sensor which can automatically determine a sufficient number of positions from which a transformation matrix can be determined in order to automatically convert position values between a sensor coordinate system of the light section sensor and a reference coordinate system of the robot kinematics system.

The object is achieved by a method for calibrating a light section sensor with respect to one member of a robot kinematics system which can be controlled by a robot control device and has a plurality of members and joints which adjustably connect the members to each other, wherein the light section sensor is fastened to the one member, comprising the steps:
Providing a calibration object with a first line feature and a second line feature different from the first line feature on a base surface in a pose known to the robot control device,
Recording an intersection point of the first line feature and second line feature by means of a teach-in method and saving the position of the intersection point in the robot coordinate system in the robot control device,
Automatically moving the light section sensor in a first vertical position along a first section, which is parallel to the first line feature, in the direction of the second line feature of the calibration object until the projected line hits the second line feature of the calibration object, and saving the current position of a predetermined reference point of the robot kinematics system in the robot coordinate system as a first calibration position,
Automatically moving the light section sensor along a second section, which is parallel to the first line feature and is different from the first section, in the direction of the second line feature of the calibration object until the projected line hits the second line feature of the calibration object, and saving the current position of the predetermined reference point of the robot kinematics system in the robot coordinate system as a second calibration position, and
Automatically moving the light section sensor in a second vertical position, which is different from the first vertical position, along a third section, which is parallel to the first line feature and is different from the first section and the second section, in the direction of the second line feature of the calibration object until the projected line hits the second line feature of the calibration object, and saving the current position of the predetermined reference point of the robot kinematics system in the robot coordinate system as a third calibration position.

In automated manufacturing, robot systems are used to be able to carry out a variety of different manufacturing processes automatically. Robot systems consist of at least one robot kinematics system, such as a robot arm, which can be automatically controlled by a robot control device, i.e. the joint positions of the robot kinematics system can be automatically adjusted. With such robot systems and specific associated tools which are automatically guided by the robot kinematics system, it is possible, for example, to create weld seams, apply adhesive beads or apply sealants to a workpiece via a nozzle guided by the robot kinematics system.

The desired path along which a reference point of a tool guided by the robot kinematics system, such as a welding gun tip, a glue nozzle or an application nozzle, should automatically move can be saved in the robot control device. A robot program can retrieve the saved path in order to automatically guide the corresponding tool along the desired path by automatically adjusting the joints of the robot kinematics system by means of the robot control device.

Since each individual workpiece can have certain deviations in its actual shape from its ideal shape, it is often not sufficient for the saved path, which represents a target path, to be followed in the same way for each individual workpiece. Therefore, so-called seam tracking is implemented which comprises an optical sensor which is preferably attached to a flange of the robot kinematics system and which, during a movement of the tool along the desired path, optically detects a feature of the workpiece associated with the path so that this feature can be evaluated by the robot control device. The feature on the workpiece can, for example, be the joint between two joined components that are connected by means of a weld seam. The feature on the workpiece can, for example, also be a groove or an edge on a workpiece along which an adhesive bead or a sealing bead is to be applied.

The optical sensor detects the feature on the workpiece at every moment of the movement of the tool along the target path and detects deviations in the pose of the tool that may arise with respect to the feature on the workpiece. The robot control device is designed and configured to automatically move the tool guided by the robot kinematics system on an actual path deviating from the target path due to occurring deviations that were detected by the optical sensor. In such a case, the actual path is then modified from the saved target path according to the deviations present in the individual case of a workpiece, and the tool is accordingly automatically moved by the robot kinematics system.

The feature according to which the robot control device is designed means that the robot control device is structurally built in this particular way. The feature according to which the robot control device is configured means that the robot control device is programmed in this specific way by means of a program or software for control purposes.

The optical sensor that is suitable in conjunction with such seam tracking is also called a light section sensor. A light section sensor typically comprises a laser light source and an optical system that expands the generated laser light into a flat fan beam or, by means of a beam deflection unit, continuously deflects a laser beam within a predetermined angular range in order to repeatedly cover this angular range. This allows an optical line to be projected onto the respective workpiece.

The projected line can be captured and evaluated by an optical camera. The optical camera is usually combined together with the laser light source in a common device of the light section sensor. The light section sensor as a standalone sensor device can be attached to a member of the robot kinematics system, in particular to a tool flange of the robot kinematics system.

Typically, the sensor values, i.e. the recorded position values of the light section sensor, are provided with respect to a sensor coordinate system. The path that is to be followed by the tool, automatically guided by the robot kinematics system, is usually in the form of support points that are present or saved as position values in a robot coordinate system.

The robot coordinate system can generally be placed anywhere in the robot kinematics system. Typically, a basic robot coordinate system is placed in the proximal base member such as the base frame of the robot kinematics system. This means that the position and orientation of the robot coordinate system remains the same in all possible axis positions or poses of the robot kinematics system. This robot coordinate system can also be called a basic coordinate system. In general, the light section sensor is attached to the last, distal end member of the robot kinematics system. This distal end member of the robot kinematics system can also be called a flange or tool flange. Since the tool to be handled by the robot kinematics system, such as a welding tool, will usually also be attached there, it is then also advisable to attach the light section sensor there. It is usually advisable to attach the light section sensor to this member, but the light section sensor can generally also be attached to any other member in the robot kinematics system. In both cases, it is then also useful to place a separate reference coordinate system in the member to which the light section sensor is to be or is attached. This reference coordinate system can then also be referred to as a flange coordinate system or hand coordinate system, depending on the case. The reference coordinate system selected in the respective specific case should be determined in such a way that, when the light section sensor is attached, its position and orientation with respect to the sensor coordinate system no longer changes, i.e. is fixed, even if the joints of the robot kinematics system are adjusted, i.e. the robot kinematics system are moved.

In order for the sensor values recorded by the guided light section sensor to be able to be correctly evaluated, they must be converted from the sensor coordinate system in which they are present into the specific reference coordinate system. Such a conversion can be performed, for example, using a transformation matrix. However, the transformation matrix depends on the exact position and orientation (pose) of the light-section sensor, i.e. the sensor device, to the member of the robot kinematics system to which the light section sensor or the sensor device is attached.

Therefore, after the light section sensor has been mounted for the first time on the relevant member of the robot kinematics system, the light section sensor must be calibrated with respect to the robot kinematics system.

For this purpose, at least three different positions of the light section sensor must be assumed with respect to a calibration object, and the associated position values must be recorded in each of these positions. From the obtained at least three position values, a transformation matrix can be calculated which allows a computational transformation between the sensor coordinate system of the light section sensor and the reference coordinate system of the robot kinematics system. According to the invention, the detection of such at least three different positions for calibration should be able to occur automatically so that no manual action by a person is necessary.

The task mentioned at the beginning is therefore solved by:
Providing a calibration object with a first line feature and a second line feature different from the first line feature on a base surface in a pose known to the robot control device,
Recording an intersection point of the first line feature and second line feature by means of a teach-in method and saving the position of the intersection point in the robot coordinate system in the robot control device,
Automatically moving the light section sensor in a first vertical position along a first section, which is parallel to the first line feature, in the direction of the second line feature of the calibration object until the projected line hits the second line feature of the calibration object, and saving the current position of a predetermined reference point of the robot kinematics system in the robot coordinate system as a first calibration position,
Automatically moving the light section sensor along a second section, which is parallel to the first line feature and is different from the first section, in the direction of the second line feature of the calibration object until the projected line hits the second line feature of the calibration object, and saving the current position of the predetermined reference point of the robot kinematics system in the robot coordinate system as a second calibration position, and
Automatically moving the light section sensor in a second vertical position, which is different from the first vertical position, along a third section, which is parallel to the first line feature and is different from the first section and the second section, in the direction of the second line feature of the calibration object until the projected line hits the second line feature of the calibration object, and saving the current position of the predetermined reference point of the robot kinematics system in the robot coordinate system as a third calibration position.

With regard to the provision of the calibration object, the calibration object can be a body of largely arbitrary design, provided that it has at least a first line feature and one second line feature. The first line feature and the second line feature can, for example, be formed by outer edges, inner edges, shoulders, scribe lines, grooves, and/or channels on the calibration body. The calibration object can be placed on a flat surface of a machining table. The machining table can, for example, comprise clamping devices that are designed to hold a workpiece during its machining by the robot system.

The calibration body itself can be calibrated in its assumed position before the start of the further process steps, i.e. the position and orientation of the calibration body with respect to the robot coordinate system is known to the robot system. For example, position and orientation values of the calibration body can be saved in the robot control device of the robot system.

Subsequently, the intersection point of the first line feature and second line feature is recorded by means of a teach-in method and saving the position of the intersection point in the robot coordinate system in the robot control device.

It should also be mentioned here that the light section sensor should be attached to the member of the robot kinematics system before starting the further process steps.

In particular, the light section sensor is moved in a central alignment along the first line feature, automatically controlled by the robot kinematics system and the robot control device, namely in a second direction. The second direction is to that extent aligned perpendicular to the light fan spanned by the emitted laser light from the light section sensor. The light section sensor is moved in this second direction until the projected line of the light section sensor hits the second line feature of the calibration object. At this moment, the current position of the light section sensor is saved in the form of position values in the robot coordinate system as a position in the second direction in the robot control device. This saved second position then forms a second calibration position. This second calibration position is to that extent also determined automatically, as is the case with the first calibration position.

The procedure for automatically determining the third calibration position can substantially correspond to the procedure for automatically determining the first calibration position or the second calibration position, wherein the automatic determination takes place, for example, in a second vertical position of the light section sensor different from the first vertical position.

In a further development of the method, the automatic movement of the light section sensor in the first vertical position along the first section, which is parallel to the first line feature, in the direction of the second line feature of the calibration object can be performed starting from a first starting position which is obtained by the following steps:
Pre-positioning the light section sensor with respect to the calibration object in the first vertical position with respect to the calibration object by controlled adjustment of the joints of the robot kinematics system controlled by the robot control device such that a line projected by the light section sensor lies outside the first line feature of the calibration object,
Automatically moving the light section sensor in the first vertical position in a first direction, which is parallel to the projected line, in the direction of the first line feature of the calibration object until the projected line hits the first line feature of the calibration object, and saving the current position of the predetermined reference point of the robot kinematics system in the robot coordinate system as a first position in the first direction,
Automatically moving the light section sensor further in the first direction, which is parallel to the projected line, over the first line feature of the calibration object while maintaining the first vertical position until the projected line leaves the first line feature of the calibration object, and saving the current position of the predetermined reference point of the robot kinematics system in the robot coordinate system as a second position in the first direction,
Automatically determining a first intermediate position in the first direction that lies between the saved first position and the saved second position, and using the first intermediate position as the first start position.

In an alternative and supplementary further development of the method, the automatic movement of the light section sensor along the second section, which is parallel to the first line feature, in the direction of the second line feature of the calibration object can be carried out starting from a second starting position which is obtained by the following steps:
Pre-positioning the light section sensor with respect to the calibration object at a specific vertical position which can in particular be the first vertical position or the second vertical position, with respect to the calibration object by controlled adjustment of the joints of the robot kinematics system controlled by the robot control device such that a line projected by the light section sensor lies outside the first line feature of the calibration object,
Automatically moving the light section sensor at the specific vertical position in a first direction, which is parallel to the projected line, in the direction of the first line feature of the calibration object until the projected line hits the first line feature of the calibration object, and saving the current position of the predetermined reference point of the robot kinematics system in the robot coordinate system as a third position in the first direction,
Automatically moving the light section sensor further in the first direction, which is parallel to the projected line, over the first line feature of the calibration object while maintaining the first vertical position until the projected line leaves the first line feature of the calibration object, and saving the current position of the predetermined reference point of the robot kinematics system in the robot coordinate system as a fourth position in the first direction,
Automatically determining a second intermediate position in the first direction which is between the saved third position and the saved fourth position, and using the second intermediate position as the second start position.

Pre-positioning the light section sensor with respect to a calibration object in the first vertical position with respect to the calibration object by controlled adjustment of the joints of the robot kinematics system controlled by the robot control device can be performed such that a line projected by the light section sensor first lies outside the first line feature of the calibration object.

Pre-positioning can be performed in that a person controls and moves the robot kinematics system, for example by means of a robot manual control device, in such a way that the light section sensor assumes a corresponding position and orientation.

An optical main axis of the light section sensor can, for example, be aligned perpendicular to the plane of the surface of the machining table and/or perpendicular to a surface of the calibration object. The light section sensor projects a line onto the surface of the machining table, or then later onto the surface of the calibration object. The projected line then also corresponds to the measuring field or the measuring line along which the optical detection device of the light section sensor can record the reflections of the emitted laser light.

The light section sensor is now automatically moved toward the calibration object parallel to the projected line or in the direction of the projected line in that the robot control device correspondingly automatically adjusts the joints of the robot kinematics system in order to correspondingly move the guided light section sensor. The vertical position of the light section sensor with respect to the surface of the machining table and/or the calibration object, i.e. the distance of the light section sensor in height from the surface of the machining table and/or from the calibration object remains constant.

In a further alternative and supplementary further development of the method, the automatic movement of the light section sensor along the third section, which is parallel to the first line feature, in the direction of the second line feature of the calibration object can be carried out starting from a second starting position which is obtained by the following steps:
Pre-positioning the light section sensor with respect to the calibration object in a further vertical position which can in particular be a third vertical position different from the first vertical position and the second vertical position, with respect to the calibration object by controlled adjustment of the joints of the robot kinematics system controlled by the robot control device such that a line projected by the light section sensor lies outside the first line feature of the calibration object,
Automatically moving the light section sensor in a further vertical position in a first direction, which is parallel to the projected line, in the direction of the first line feature of the calibration object until the projected line hits the first line feature of the calibration object, and saving the current position of the predetermined reference point of the robot kinematics system in the robot coordinate system as a fifth position in the first direction,
Automatically moving the light section sensor further in the first direction, which is parallel to the projected line, over the first line feature of the calibration object while maintaining the further vertical position until the projected line leaves the first line feature of the calibration object, and saving the current position of the predetermined reference point of the robot kinematics system in the robot coordinate system as a sixth position in the first direction,
Automatically determining a third intermediate position in the first direction which is between the saved fifth position and the saved sixth position, and using the third intermediate position as the third start position.

Accordingly, the light section sensor is automatically moved at a first vertical position in a first direction, which is parallel to the projected line, in the direction of the first line feature of the calibration object until the projected line hits the first line feature of the calibration object. As soon as the projected line hits the first line feature of the calibration object, the current position of the light section sensor is saved in the robot control device at that moment in the form of position values in the robot coordinate system as a first position in the first direction.

The light section sensor is now automatically moved further in the first direction, which is parallel to the projected line, over the first line feature of the calibration object while maintaining the first vertical position until the projected line leaves the first line feature of the calibration object. As soon as the projected line has left the first line feature of the calibration object, the current position of the light section sensor is saved in the robot control device at that moment in the form of position values in the robot coordinate system as a second position in the first direction.

The saved position values of the first position and the saved position values of the second position are both in the robot coordinate system.

Now, from the saved position value of the first position and the saved position value of the second position, an intermediate position can be determined that lies on a section between these two positions. The intermediate position should preferably be close to the planned working point of the tool. The working point can be, for example, a center point of a welding gun tip, a glue nozzle or an application nozzle. The intermediate position is saved as a first calibration position in the first direction in the robot control device.

The automatic determination of the first intermediate position in the first direction, which lies between the saved first position and the saved second position, can be performed by determining, as the first intermediate position, the point which, when the light section sensor moves from the first position to the second position, lies halfway along the section that the light section sensor travels in the first direction, and/or the automatic determination of the second intermediate position in the first direction, which lies between the saved first position and the saved second position, can be performed by determining, as the second intermediate position, the point which, when the light section sensor moves from the third position to the fourth position, lies halfway along the section that the light section sensor travels in the first direction, and/or the automatic determination of the third intermediate position in the first direction, which lies between the saved fifth position and the saved sixth position, can be performed by determining, as the third intermediate position, the point which, when the light section sensor moves from the fifth position to the sixth position, lies halfway along the section that the light section sensor travels in the first direction.

Alternatively, the automatic determination of the first intermediate position in the first direction, which lies between the saved first position and the saved second position, can be performed by determining, as the first intermediate position, the point which, when the light section sensor moves from the first position to the second position, lies at a point of the section different from halfway along the section that the light section sensor travels in the first direction, and/or the automatic determination of the second intermediate position in the first direction, which lies between the saved third position and the saved fourth position, can be performed by determining, as the second intermediate position, the point which, when the light section sensor moves from the third position to the fourth position, lies at a point of the section different from halfway along the section that the light section sensor travels in the first direction, and/or the automatic determination of the third intermediate position in the first direction, which lies between the saved fifth position and the saved sixth position, can be performed by determining, as the third intermediate position, the point which, when the light section sensor moves from the fifth position to the sixth position, lies at a point of the section different from halfway along the section that the light section sensor travels in the first direction.

A supplementary fourth calibration position or an alternative further calibration position can be obtained automatically by the further step:
Automatically moving the light section sensor in a height direction which is oriented perpendicular to the first direction and perpendicular to the second direction, in particular perpendicular to the projected line of the light section sensor, from the first vertical position to the second vertical position until the light section sensor has a higher vertical position with respect to the calibration object.

Based on at least three different saved calibration positions from the group of calibration positions comprising the first calibration position, the second calibration position, the third calibration position and the further calibration position, a mathematical transformation matrix can be automatically determined, which is designed for automatic, computational transformation between a sensor coordinate system of the light section sensor and a reference coordinate system, in particular a flange coordinate system or a hand coordinate system, of the robot kinematics system.

After providing the calibration object with the first line feature and the second line feature different from the first line feature on a base surface in a pose known to the robot control device and before automatically moving the light section sensor at the first vertical position in a first direction, which is parallel to the projected line, in the direction of the first line feature of the calibration object until the projected line hits the first line feature of the calibration object, an intersection point of the first line feature and the second line feature can be recorded by means of a teach-in method and saved in the robot control device.

The first line feature of the calibration object intersects the second line feature of the calibration object at the intersection point. In the case of a cuboid as a calibration object, the intersection point can be formed, for example, by a corner of the cuboid. However, the intersection point can also be another outer edge, inner edge or inner corner of a calibration body.

In particular, a cuboid having a known length, width and height saved in the robot control device can be used as the calibration object, wherein a first edge of the cuboid forms the first line feature, and a second edge of the cuboid, which abuts the same corner of the cuboid as the first edge, forms the second line feature.

The object is also achieved by a robot system comprising a robot control device and a robot kinematics system with a plurality of members and joints adjustably connecting the plurality of members to one another, which joints comprise electric drives which can be driven automatically by the robot control device, wherein the robot control device is designed and configured to automatically carry out a method according to any of the described embodiments.

A specific embodiment of the invention is explained in more detail in the following description with reference to the accompanying figures. Specific features of this exemplary embodiment can represent general features of the invention regardless of the specific context in which they are mentioned, optionally also considered individually or in further combinations.

### BRIEF DESCRIPTION OF THE DRAWINGS

The accompanying drawings, which are incorporated in and constitute a part of this specification, illustrate exemplary embodiments of the invention and, together with a general description of the invention given above, and the detailed description given below, serve to explain the principles of the invention.

FIG. 1 is a flow chart of steps in an exemplary basic method according to aspects of the invention,

FIG. 2 is a partial view of an exemplary configuration of a robot system according to aspects of the invention with a light section sensor and a calibration object,

FIG. 3 is a schematic representation of pre-positioning of the light section sensor such that the projected line lies outside the first line feature,

FIG. 4 is a schematic representation of automatic movement of the light section sensor until the projected line hits the first line feature,

FIG. 5 is a schematic representation of automatic further movement of the light section sensor until the projected line leaves the first line feature,

FIGS. 6 to 8 are schematic representations of the third step of the exemplary method for determining the first calibration position,

FIGS. 9 to 11 are schematic representations of the fourth step of the exemplary method for determining the second calibration position with a different intermediate position, and

FIG. 12 is a side view of an exemplary configuration of a robot system according to the aspects of the invention.

### DETAILED DESCRIPTION

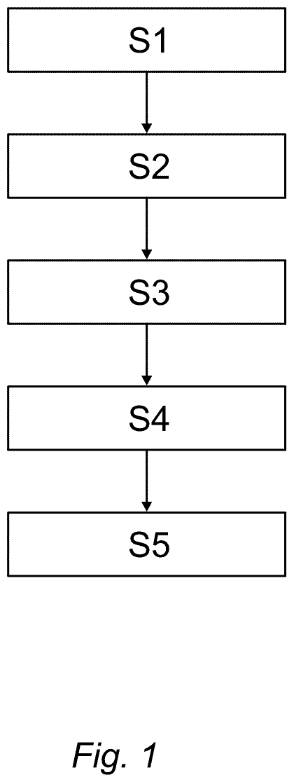

FIG. 1 shows an exemplary method for automatically calibrating a light section sensor 1 with respect to one member 2 of a robot kinematics system 4 which can be controlled by a robot control device 3 and has a plurality of members 2 and joints 5 which adjustably connect the members 2 to each another, wherein the light section sensor 1 is fastened to one member 2 which, in the case of the present embodiment, is a tool flange 2a of the robot kinematics system 4.

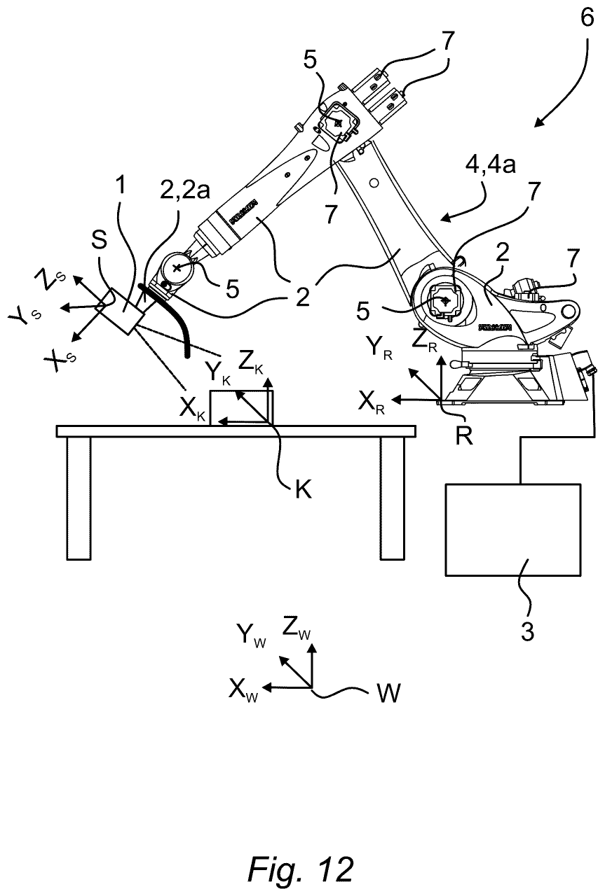

FIG. 12 shows an exemplary configuration of a robot system 6 comprising the robot control device 3 and the robot kinematics system 4 which, in the present exemplary embodiment, is designed as an articulated-arm robot 4a, with the plurality of members 2 and joints 5 adjustably connecting the plurality of members 2 to one another, which joints comprise electric drives 7 which can be driven automatically by the robot control device 3, wherein the robot control device 3 is designed and configured to automatically carry out a method according to the invention.

The method comprises the following steps, as shown in FIG. 1:

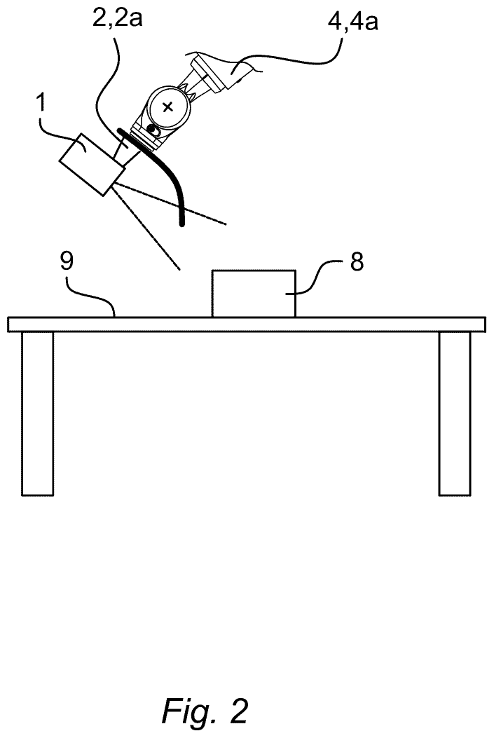

In a first step S1, a calibration object 8 with a first line feature L1 and a second line feature L2 different from the first line feature L1 is provided on a base surface 9 in a pose known to the robot control device 3. The calibration object 8, the first line feature L1, the second line feature L1 and the base surface 9 are shown in FIG. 2 and FIG. 12.

In the case of the present embodiment, the calibration object 8 is formed as a cuboid with a known length, width and height saved in the robot control device 3, wherein a first edge of the cuboid forms the first line feature L1 and a second edge of the cuboid, which abuts the same corner 11a of the cuboid as the first edge, forms the second line feature L2.

After providing the calibration object 8 with the first line feature L1 and the second line feature L2 different from the first line feature L1 on the base surface 9 in a pose known to the robot control device 3 and before automatically moving the light section sensor 1 in the first vertical position in a first direction R1, which is parallel to the projected line 10, in the direction of the first line feature L1 of the calibration object 8 until the projected line 10 hits the first line feature L1 of the calibration object 8, in a second step S2, an intersection point 11 of the first line feature L1 and second line feature L2 can be recorded by means of a teach-in method and saved in the robot coordinate system in the robot control device 3. In the case of the present embodiment, the intersection point 11 is accordingly formed by the corner 11a of the cuboid.

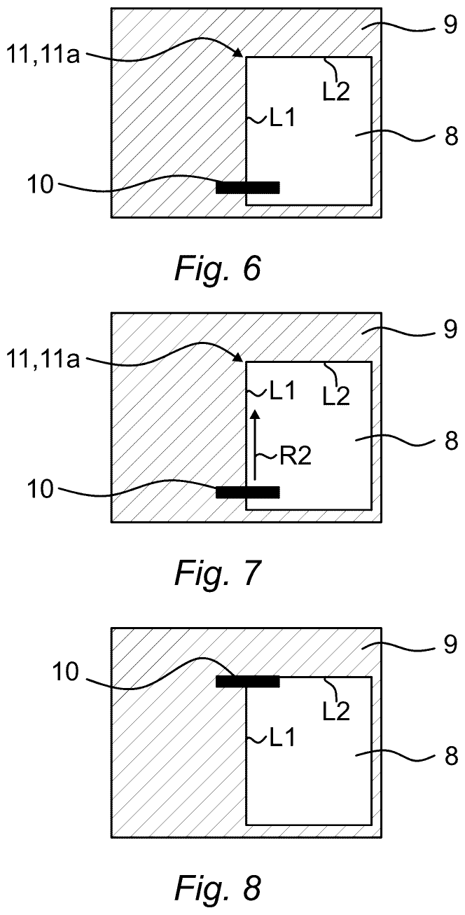

In a third step S3, the light section sensor 1 is automatically moved in the first vertical position along a first section, which is parallel to the first line feature L1, in the direction of the second line feature L2 of the calibration object 8 until the projected line 10 hits the second line feature L2 of the calibration object 8, and the current position of a predetermined reference point of the robot kinematics system 4 is saved in the robot coordinate system R as a first calibration position. This is illustrated in particular in FIG. 6 to 8.

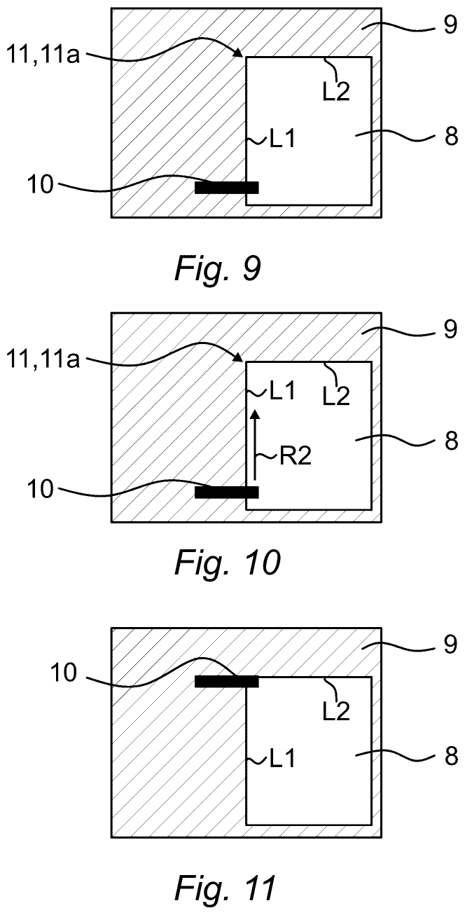

In a fourth step S4, the light section sensor 1 is automatically moved along a second section, which is parallel to the first line feature L1 and is different from the first section, in the direction of the second line feature L2 of the calibration object 8 until the projected line 10 hits the second line feature L2 of the calibration object 8, and the current position of the predetermined reference point of the robot kinematics system 4 is saved in the robot coordinate system R as a second calibration position. This is illustrated in particular in FIG. 9 to 11.

In a fifth step S5, the light section sensor 1 is automatically moved in a second vertical position, which is different from the first vertical position, along a third section, which is parallel to the first line feature L1 and which is different from the first section and the second section, in the direction of the second line feature L2 of the calibration object 8 until the projected line 10 hits the second line feature L2 of the calibration object 8, and the current position of the predetermined reference point of the robot kinematics system 4 is saved in the robot coordinate system R as a third calibration position.

In a first development of the exemplary method, the automatic movement of the light section sensor 1 in the first vertical position along the first section, which is parallel to the first line feature L1, in the direction of the second line feature L2 of the calibration object 8 can take place starting from a first starting position which is obtained by the following steps.

In a first step, the light section sensor 1 is pre-positioned with respect to the calibration object 8 at the first vertical position with respect to the calibration object 8 by controlled adjustment of the joints 5 of the robot kinematics system 4 controlled by the robot control device 3 such that a line 10 projected by the light section sensor 1 lies outside the first line feature L1 of the calibration object 8,

In a second step, the light section sensor 1 is automatically moved in the first vertical position in a first direction R1, which is parallel to the projected line 10, in the direction of the first line feature L1 of the calibration object 8 until the projected line 10 hits the first line feature L1 of the calibration object 8, and the current position of the predetermined reference point of the robot kinematics system 4 is saved in the robot coordinate system R as a first position in the first direction R1,

In a third step, the light section sensor 1 is automatically moved further in the first direction R1, which is parallel to the projected line 10, over the first line feature 10 of the calibration object 8 while maintaining the first vertical position until the projected line 10 leaves the first line feature L1 of the calibration object 8, and the current position of the predetermined reference point of the robot kinematics system 4 is saved in the robot coordinate system R as a second position in the first direction R1,

And in a fourth step, a first intermediate position in the first direction R1 that lies between the saved first position and the saved second position is automatically determined, and the first intermediate position is used as the first start position.

In an alternative or supplementary further development of the exemplary method, the automatic movement of the light section sensor 1 along the second section, which is parallel to the first line feature L1, in the direction of the second line feature L2 of the calibration object 8 can be performed starting from a second starting position which is obtained by the following steps:

Pre-positioning the light section sensor 1 with respect to the calibration object 8 at a specific vertical position, which can in particular be the first vertical position or the second vertical position, with respect to the calibration object 8 by controlled adjustment of the joints 5 of the robot kinematics system 4 controlled by the robot control device 3 such that a line 10 projected by the light section sensor 1 lies outside the first line feature L1 of the calibration object 8,

Automatically moving the light section sensor 1 at the specific vertical position in a first direction R1, which is parallel to the projected line 10, in the direction of the first line feature L1 of the calibration object 8 until the projected line 10 hits the first line feature L1 of the calibration object 8, and saving the current position of the predetermined reference point of the robot kinematics system 4 in the robot coordinate system R as a third position in the first direction R1,

Automatically moving the light section sensor 1 further in the first direction R1, which is parallel to the projected line 10, over the first line feature 10 of the calibration object 8 while maintaining the first vertical position until the projected line 10 leaves the first line feature L1 of the calibration object 8, and saving the current position of the predetermined reference point of the robot kinematics system 4 in the robot coordinate system R as a fourth position in the first direction R1,

Automatically determining a second intermediate position in the first direction R1 which is between the saved third position and the saved fourth position, and using the second intermediate position as the second start position.

In a further, alternative or supplementary further development of the exemplary method, the automatic movement of the light section sensor 1 along the third section, which is parallel to the first line feature L1, in the direction of the second line feature L2 of the calibration object 8 can be performed starting from a third starting position, which is obtained by the following steps:

Pre-positioning the light section sensor 1 with respect to the calibration object 8 in a further vertical position, which can in particular be a third vertical position different from the first vertical position and the second vertical position, with respect to the calibration object 8 by controlled adjustment of the joints 5 of the robot kinematics system 4 controlled by the robot control device 3 such that a line 10 projected by the light section sensor 1 lies outside the first line feature L1 of the calibration object 8,

Automatically moving the light section sensor 1 in a further vertical position in a first direction R1, which is parallel to the projected line 10, in the direction of the first line feature L1 of the calibration object 8 until the projected line 10 hits the first line feature L1 of the calibration object 8, and saving the current position of the predetermined reference point of the robot kinematics system 4 in the robot coordinate system R as a fifth position in the first direction R1,

Automatically moving the light section sensor 1 further in the first direction R1, which is parallel to the projected line 10, over the first line feature 10 of the calibration object 8 while maintaining the further vertical position until the projected line 10 leaves the first line feature L1 of the calibration object 8, and saving the current position of the predetermined reference point of the robot kinematics system 4 in the robot coordinate system R as a sixth position in the first direction R1,

Automatically determining a third intermediate position in the first direction R1 which is between the saved fifth position and the saved sixth position, and using the third intermediate position as the third start position.

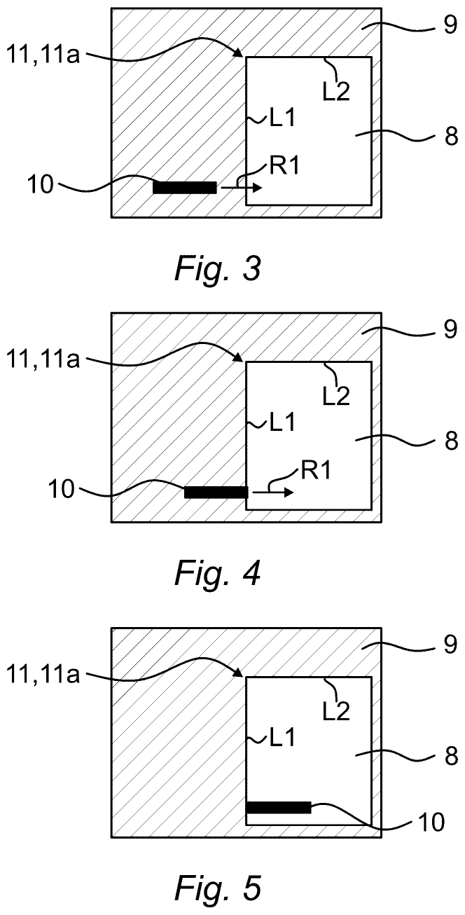

In the case of the steps according to FIG. 6 to FIG. 8, the automatic determination of the intermediate position in the first direction R1, which lies between the saved first position and the saved second position, takes place in that the point which, when the light section sensor 1 moves from the first position to the second position, lies halfway along the section that the light section sensor 1 travels in the first direction R1 is determined as the intermediate position (FIG. 3 to FIG. 5), and/or the automatic determination of a second intermediate position in the first direction R1, which lies between the saved third position and the saved fourth position, takes place in that the point which, when the light section sensor 1 moves from the third position to the fourth position, lies halfway along the section that the light section sensor 1 travels in the first direction R1 is determined as the second intermediate position.

In the case of the steps according to FIG. 9 to FIG. 11, however, the automatic determination of the intermediate position in the first direction R1, which lies between the saved first position and the saved second position, takes place in that the point is determined as the intermediate position which, when the light section sensor 1 moves from the first position to the second position, lies at a point of the section different from halfway along the section that the light section sensor travels in the first direction (FIG. 3 to FIG. 5), and/or the automatic determination of the second intermediate position in the first direction, which lies between the saved third position and the saved fourth position, takes place in that the point is determined as the second intermediate position which, when the light section sensor 1 moves from the third position to the fourth position, lies at a point of the section different from halfway along the section that the light section sensor 1 travels in the first direction R1. In the embodiment according to FIG. 9 to FIG. 11, the intermediate position can be located on a point of the section of the projected line 10 which, as shown, divides the projected line 10 into subsections of, for example, three-quarters and one-quarter.

Based on at least three different saved calibration positions from the group of calibration positions comprising the first calibration position, the second calibration position, the third calibration position and the further calibration position, a mathematical transformation matrix can be automatically determined, which is designed for automatic, computational transformation between a sensor coordinate system S (FIG. 12) of the light section sensor 1 and a robot coordinate system R of the robot kinematics system 4. The calibration object 8 can be assigned its own calibration object coordinate system K. The pose of the calibration object coordinate system K can be known with respect to the robot coordinate system R of the robot control device R. In addition, a further world coordinate system W may be defined if necessary, which can form a common reference point with regard to the poses of the robot coordinate system R, the calibration object coordinate system K and the sensor coordinate system S.

The third calibration position can be obtained, for example, by again performing the method as illustrated in FIG. 3 to FIG. 5, or the method as illustrated in FIG. 6 to FIG. 8 or as illustrated in FIG. 9 to FIG. 11, namely this time not in the first vertical position, but in a second vertical position different from the first vertical position.

Accordingly, the light section sensor 1 can be automatically moved in a height direction that is oriented perpendicular to the first direction R1 and perpendicular to the second direction R2, in particular perpendicular to the projected line 10 of the light section sensor 1, from the first vertical position to a second vertical position until the light section sensor 1 has a higher vertical position with respect to the calibration object 8.

Subsequently, the light section sensor 1 can be pre-positioned with respect to the calibration object 8 in the second vertical position with respect to the calibration object 8 by controlled adjustment of the joints 5 of the robot kinematics system 4 controlled by the robot control device 3 such that a line 10 projected by the light section sensor 1 lies outside the first line feature L1 of the calibration object 8.

The light section sensor 1 can then be moved automatically at the second vertical position, in a first direction R1, which is parallel to the projected line 10, in the direction of the first line feature L1 of the calibration object 8, until the projected line 10 hits the first line feature L1 of the calibration object 8, wherein the current position of the light section sensor 1 is also saved in the robot coordinate system R as a first position in the first direction R1.

Subsequently, the light section sensor 1 can be automatically moved further in the first direction R1, which is parallel to the projected line 10, over the first line feature L1 of the calibration object 8 while maintaining the second vertical position until the projected line 10 leaves the first line feature L1 of the calibration object 8, wherein the current position of the light section sensor 1 is saved in the robot coordinate system R as a second position in the first direction R1.

Finally, a second intermediate position in the first direction R1 can be automatically determined, which lies between the saved first position and the saved second position, wherein the second intermediate position is also saved as a third calibration position in the first direction R1.

Alternatively, the light section sensor 1 can be automatically moved in a height direction that is oriented perpendicular to the first direction R1 and perpendicular to the second direction R2, which in particular runs perpendicular to the projected line 10 of the light section sensor 1, from the first vertical position to the second vertical position until the light section sensor 1 has a higher vertical position with respect to the calibration object 8.

The light section sensor 1 can then be automatically moved at the second vertical position in the second direction R2 perpendicular to the projected line 10 in the direction of the second line feature L2 of the calibration object 8 until the projected line 10 hits the second line feature L2 of the calibration object 8, wherein the current position of the light section sensor 1 is saved in a robot coordinate system R as a further position in the second direction R2. The further position can accordingly in particular form a third or further calibration position in the second direction R2.

While the present invention has been illustrated by a description of various embodiments, and while these embodiments have been described in considerable detail, it is not intended to restrict or in any way limit the scope of the appended claims to such de-tail. The various features shown and described herein may be used alone or in any combination. Additional advantages and modifications will readily appear to those skilled in the art. The invention in its broader aspects is therefore not limited to the specific details, representative apparatus and method, and illustrative example shown and described. Accordingly, departures may be made from such details without departing from the spirit and scope of the general inventive concept.

What is claimed is:

1. A method for calibrating a light section sensor (1) with respect to one member (2) of a robot kinematics system (4) which can be controlled by a robot control device (3) and has a plurality of members (2) and joints (5) which adjustably connect the members (2) to each other, wherein the light section sensor (1) is fastened to the one member (2), comprising the steps of:
Providing a calibration object (8) with a first line feature (L1) and a second line feature (L2), which is different from the first line feature (L1), on a base surface (9) in a pose known to the robot control device (3),
Recording an intersection point (11) of the first line feature (L1) and second line feature (L2) by means of a teach-in method and saving the position of the intersection point (11) in the robot coordinate system (R) in the robot control device (3),
Automatically moving the light section sensor (1) in a first vertical position along a first section, which is parallel to the first line feature (L1), in the direction of the second line feature (L2) of the calibration object (8) until the projected line (10) hits the second line feature (L2) of the calibration object (8), and saving the current position of a predetermined reference point of the robot kinematics system (4) in the robot coordinate system (R) as a first calibration position,
Automatically moving the light section sensor (1) along a second section, which is parallel to the first line feature (L1) and is different from the first section, in the direction of the second line feature (L2) of the calibration object (8) until the projected line (10) hits the second line feature (L2) of the calibration object (8), and saving the current position of the predetermined reference point of the robot kinematics system (4) in the robot coordinate system (R) as a second calibration position, and
Automatically moving the light section sensor (1) in a second vertical position, which is different from the first vertical position, along a third section, which is parallel to the first line feature (L1) and is different from the first section and the second section, in the direction of the second line feature (L2) of the calibration object (8) until the projected line (10) hits the second line feature (L2) of the calibration object (8), and saving the current position of the predetermined reference point of the robot kinematics system (4) in the robot coordinate system (R) as a third calibration position.

2. The method according to claim 1, characterized in that the automatic movement of the light section sensor (1) in the first vertical position along the first section, which is parallel to the first line feature (L1), in the direction of the second line feature (L2) of the calibration object (8) takes place starting from a first starting position which is obtained by the following steps:
Pre-positioning the light section sensor (1) with respect to the calibration object (8) at the first vertical position with respect to the calibration object (8) by controlled adjustment of the joints (5) of the robot kinematics system (4) controlled by the robot control device (3) such that a line (10) projected by the light section sensor (1) lies outside the first line feature (L1) of the calibration object (8),
Automatically moving the light section sensor (1) in the first vertical position in a first direction (R1), which is parallel to the projected line (10), in the direction of the first line feature (L1) of the calibration object (8) until the projected line (10) hits the first line feature (L1) of the calibration object (8), and saving the current position of the predetermined reference point of the robot kinematics system (4) in the robot coordinate system (R) as a first position in the first direction (R1),
Automatically moving the light section sensor (1) further in the first direction (R1), which is parallel to the projected line (10), over the first line feature (10) of the calibration object (8) while maintaining the first vertical position until the projected line (10) leaves the first line feature (L1) of the calibration object (8), and saving the current position of the predetermined reference point of the robot kinematics system (4) in the robot coordinate system (R) as a second position in the first direction (R1),
Automatically determining a first intermediate position in the first direction (R1) that lies between the saved first position and the saved second position, and using the first intermediate position as the first start position.

3. The method according to claim 1, characterized in that the automatic movement of the light section sensor (1) along the second section, which is parallel to the first line feature (L1), in the direction of the second line feature (L2) of the calibration object (8) takes place starting from a second starting position which is obtained by the following steps:
Pre-positioning the light section sensor (1) with respect to the calibration object (8) at a specific vertical position, which can in particular be the first vertical position or the second vertical position, with respect to the calibration object (8) by controlled adjustment of the joints (5) of the robot kinematics system (4) controlled by the robot control device (3) such that a line (10) projected by the light section sensor (1) lies outside the first line feature (L1) of the calibration object (8),
Automatically moving the light section sensor (1) at the specific vertical position in a first direction (R1), which is parallel to the projected line (10), in the direction of the first line feature (L1) of the calibration object (8) until the projected line (10) hits the first line feature (L1) of the calibration object (8), and saving the current position of the predetermined reference point of the robot kinematics system (4) in the robot coordinate system (R) as a third position in the first direction (R1),
Automatically moving the light section sensor (1) further in the first direction (R1), which is parallel to the projected line (10), over the first line feature (10) of the calibration object (8) while maintaining the first vertical position until the projected line (10) leaves the first line feature (L1) of the calibration object (8), and saving the current position of the predetermined reference point of the robot kinematics system (4) in the robot coordinate system (R) as a fourth position in the first direction (R1),
Automatically determining a second intermediate position in the first direction (R1) that lies between the saved third position and the saved fourth position, and using the second intermediate position as the second start position.

4. The method according to claim 1, characterized in that the automatic movement of the light section sensor (1) along the third section, which is parallel to the first line feature (L1), in the direction of the second line feature (L2) of the calibration object (8) takes place starting from a third starting position which is obtained by the following steps:
Pre-positioning the light section sensor (1) with respect to the calibration object (8) in a further vertical position, which can in particular be a third vertical position different from the first vertical position and the second vertical position, with respect to the calibration object (8) by controlled adjustment of the joints (5) of the robot kinematics system (4) controlled by the robot control device (3) such that a line (10) projected by the light section sensor (1) lies outside the first line feature (L1) of the calibration object (8),
Automatically moving the light section sensor (1) in a further vertical position in a first direction (R1), which is parallel to the projected line (10), in the direction of the first line feature (L1) of the calibration object (8) until the projected line (10) hits the first line feature (L1) of the calibration object (8), and saving the current position of the predetermined reference point of the robot kinematics system (4) in the robot coordinate system (R) as a fifth position in the first direction (R1),
Automatically moving the light section sensor (1) further in the first direction (R1), which is parallel to the projected line (10), over the first line feature (10) of the calibration object (8) while maintaining the further vertical position until the projected line (10) leaves the first line feature (L1) of the calibration object (8), and saving the current position of the predetermined reference point of the robot kinematics system (4) in the robot coordinate system (R) as a sixth position in the first direction (R1),
Automatically determining a third intermediate position in the first direction (R1) that lies between the saved fifth position and the saved sixth position, and using the third intermediate position as the third start position.

5. The method according to claim 2, characterized in that the point is determined as the first intermediate position which, when the light section sensor (1) moves from the first position to the second position, lies halfway along the section that the light section sensor (1) travels in the first direction (R1), and/or the point is determined as the second intermediate position which, when the light section sensor (1) moves from the third position to the fourth position, lies halfway along the section that the light section sensor (1) travels in the first direction (R1), and/or the point is determined as the third intermediate position which, when the light section sensor (1) moves from the fifth position to the sixth position, lies halfway along the section that the light section sensor (1) travels in the first direction (R1).

6. The method according to claim 2, characterized in that the point is determined as the first intermediate position which, when the light section sensor (1) moves from the first position to the second position, lies at a point of the section which is different from halfway along the section that the light section sensor (1) travels in the first direction (R1), and/or the point is determined as the second intermediate position which, when the light section sensor (1) moves from the third position to the fourth position, lies at a point of the section which is different from halfway along the section that the light section sensor (1) travels in the first direction (R1), and/or the point is determined as the third intermediate position which, when the light section sensor (1) moves from the fifth position to the sixth position, lies at a point of the section which is different from halfway along the section that the light section sensor (1) travels in the first direction (R1).

7. The method according to claim 1, characterized in that on the basis of at least three different saved calibration positions from the group of calibration positions comprising the first calibration position, the second calibration position, the third calibration position and optionally a further calibration position, a mathematical transformation matrix is automatically determined, which is designed for the automatic, computational transformation between a sensor coordinate system(S) of the light section sensor (1) and a reference coordinate system (R), in particular a flange coordinate system or a hand coordinate system, of the robot kinematics system (4).

8. The method according to claim 1, characterized by the further step of:
Automatically moving the light section sensor (1) in a height direction which is oriented perpendicular to the first direction (R1) and perpendicular to a second direction (R2), in particular perpendicular to the projected line (10) of the light section sensor (1), from the first vertical position to the second vertical position until the light section sensor (1) has a higher vertical position with respect to the calibration object (8).

9. The method according to claim 1, characterized in that a cuboid with a known length, width and height saved in the robot control device (3) is used as the calibration object (8), wherein a first edge of the cuboid forms the first line feature (L1) and a second edge of the cuboid, which abuts the same corner (11a) of the cuboid as the first edge, forms the second line feature (L2).

10. A robot system comprising a robot control device (3) and a robot kinematics system (4) with a plurality of members (2) and joints (5) which adjustably connect the plurality of members (2) to each other and comprise electric drives (7) which can be driven automatically by the robot control device (3), wherein the robot control device (3) is designed and configured to automatically carry out a method according to claim 1.
